(19) United States
(12) Patent Application Publication
(10) Pub. No.: US 2007/0252340 A1
(43) Pub. Date: Nov. 1, 2007

(54) SEAL IN HIGH-PRESSURE DEVICES

(75) Inventors: Reinhard KARL, Klosterneuburg (AT); Gerald RETSCHNIK, Niklasdorf (AT); Franz TRIEB, Kapfenberg (AT)

Correspondence Address: GREENBLUM & BERNSTEIN, P.L.C., 1950 ROLAND CLARKE PLACE, RESTON, VA, 20191, US

(73) Assignee: BOEHLER HOCHDRUCKTECHNIK GMBH, Kapfenberg (AT)

(21) Appl. No.: 11/734,929

(22) Filed: Apr. 13, 2007

(30) Foreign Application Priority Data
Apr. 14, 2006 (AT) A-654/2006

(51) Int. Cl. F16J 15/00

(52) U.S. Cl. 277/534

(57) ABSTRACT

The invention relates to a seal of parts moveable relative to one another of high-pressure devices for liquid media, comprising a high-pressure container, into the opening of which the moveable part and, coaxially around this part toward the high-pressure side, a sleeve project, and a support ring on the front exterior area of the projecting sleeve bears against the interior surface of the opening of the high-pressure container and against a ring. In order to avoid as far as possible the wear and the material abrasion often in individual places in the contact area between pressure container and support ring with repeated compressive load and to increase the service life of the seal of high-pressure devices in this manner, it is provided according to the invention that at least the exterior surface of the support ring and/or at least the interior surface of the opening of the high-pressure container, which surface bears against the support ring or the sealant, has at least one coating applied according to a PVD (Physical Vapor Deposition) method, and/or a CVD (Chemical Vapor Deposition) method, and/or in particular a PACVD (Plasma-Assisted Chemical Vapor Deposition) method.

### CROSS-REFERENCE TO RELATED APPLICATIONS

The present application claims priority under 35 U.S.C. § 119 of Austrian Patent Application No. A 654/2006 filed Apr. 14, 2006, the disclosure of which is expressly incorporated by reference herein in its entirety.

### BACKGROUND OF THE INVENTION

1. Field of the Invention

The invention relates to a seal of parts moveable relative to one another of high-pressure devices, in particular of plungers moved in an oscillating manner of high-pressure pumps, for liquid media, comprising a metallic high-pressure container or a like cylinder, into the opening of which the moveable part and, coaxially around this part toward the high-pressure side, a sleeve, in particular a metallic bushing, project, and a metallic support ring on the front exterior area of the projecting sleeve bears against the interior surface of the opening of the high-pressure container and against a ring or a pressing ring, which ring is in contact with the sleeve in the interior area or in the front area adjacent to the moved part.

2. Discussion of Background Information

A sealing system of this type is described, e.g., in EP 0 505 352 B1, whereby the present invention, however, does not refer exclusively to this arrangement for sealing moveable parts of high-pressure devices.

The mode of operation of a high-pressure seal toward the outside is to be seen essentially in that a sealing for liquid media with pressures of up to 1000 MPa, preferably with pressures of 300 to 600 MPa, between a high-pressure container or high-pressure cylinder and a moved part projecting into it, in particular a plunger, is carried out by a bushing or sleeve usually guiding the part, which bushing or sleeve on the one hand has a sealing function toward the moved part and on the other hand interacts in a sealing manner with a sealing ring or support ring toward the interior surface of the bore in the high-pressure container. A protruding part of the bushing or sleeve and the sealing ring or support ring are acted upon with forces by a ring or pressure part from the high-pressure area and positioned in a sealing manner against the moved part and on the interior surface of the bore.

Signs of wear by material abrasion from both parts are found on the contact surface between sealing ring or support ring and the interior surface of the bore or of the cylinder after different operating times of a pump installation, as the case may be. A wear of this type can cause a failure of the sealing system after shorter or longer operating times.

Extensive tribological tests, however, did not show any definite connections between the type of wear, the speed of wear, the materials of pressure cylinder and support ring and the conditions of pressure liquid or press water.

It has not yet been possible to scientifically clarify the reason for the signs of wear on the contact surfaces between the wall of the high-pressure container and the sealing ring or support ring, on the one hand, because it is not possible to estimate the tribological stress variables according to DIN 50320 and, on the other hand, because previous measures to overcome the problem did not show the beginnings of a solution.

### SUMMARY OF THE INVENTION

The invention avoids, as far as possible, the wear and the material abrasion often in individual places in the contact area between pressure container and sealing ring or support ring with repeated compressive load and to increase the service life of the seal of high-pressure devices in this manner.

According to the invention, at least the exterior surface of the support ring and/or at least the interior surface of the opening of the high-pressure container, which surface bears against the support ring or the sealant, has at least one coating applied according to a PVD (Physical Vapor Deposition) method, and/or a CVD (Chemical Vapor Deposition) method, and/or in particular a PACVD (Plasma-Assisted Chemical Vapor Deposition) method.

Surprisingly, the coating according to the invention of the exterior surface of the support ring and/or of the interior surface of the opening of the high-pressure container or of the high-pressure cylinder creates a favorable wear characteristic in the contact area of the parts with the tribological stress variables given.

Although there has not yet been a clarification of the fact and the extent of a contact deformation according to the Hertzian theory and an impingement wear and impact wear and the fact and extent of a friction despite the highest possible stability of a fixing of the parts, which could previously cause the material damage, i.e., the wear mechanisms such as abrasion, surface disruption, adhesion or tribological reactions, a high wear protection could be achieved with a coating according to the invention.

Even after a long operating time of the high-pressure device, small-scale material abrasions on the contact surface could not be determined on the bore surface or on the support ring surface, even if only one of the surfaces was coated according to the invention.

Without sufficient technical-scientific proof of a mode of operation of the coating, it can be assumed that the coat acts as an impediment to a local pressure-welding connection of the materials, as a diffusion barrier on the surfaces and as a friction reduction with a uniform movement of the parts with high contact pressures.

In order to prevent a breaking through the coating as a result of deformations of the substrate with a specific stress that is still high despite being planar, and thus to extend the service life of the seal, it is advantageous for the support ring and/or the high-pressure container with the opening to be formed of a stainless steel with a hardness of more than 28 HRC, preferably of a stainless steel with special additives, in particular of a steel according to DIN material no. 1.4545.

It is thus also rendered possible to minimize disadvantageous signs of corrosion that may occur in particular with a standstill of the high-pressure pump.

In practical operation it has proven to be particularly advantageous for long operating times at full load for the coating to be formed of several individual layers, as a so-called “multiple layer” coating.

If the coating or at least one layer of the same is formed as a carbide, nitride or carbonitride layer, as can be provided in a favorable manner with respect to a steel alloyed with chromium as a base material, this results in very hard coatings with improved friction properties and/or a like stability of the coatings, and a considerably extended durability even in uninterrupted operation.

It has proven to be particularly advantageous for a wear minimization of the contact surfaces for the coating or the interior layer of the multiple-layer coating, which layer is connected to the partial surface, to be formed with chromium nitride. Apparently, it is thus possible to achieve a particularly good adhesion of the coating to the partial surface, in particular of a precipitation-hardening alloy containing chromium.

A further preferred embodiment of the invention provides, if a coating or the exterior layer of the multiple-layer coating is formed as a carbon layer containing metal or free of metal, a durability of the seal is substantially increased even with impure liquid media.

The sealing behavior was found to be advantageous with low wear of the press surfaces if the exterior surface of the support ring and the interior surface of the opening bear a (CrN) coating.

Although the (CrN) sandwiches have only a low microhardness (HV 0.05) of approximately 1750, as compared to other layered materials, a considerably improved long-term sealing effect resulted from a coating of both contact surfaces.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 diagrammatically illustrates an embodiment of an arrangement for sealing moveable parts of high-pressure devices.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

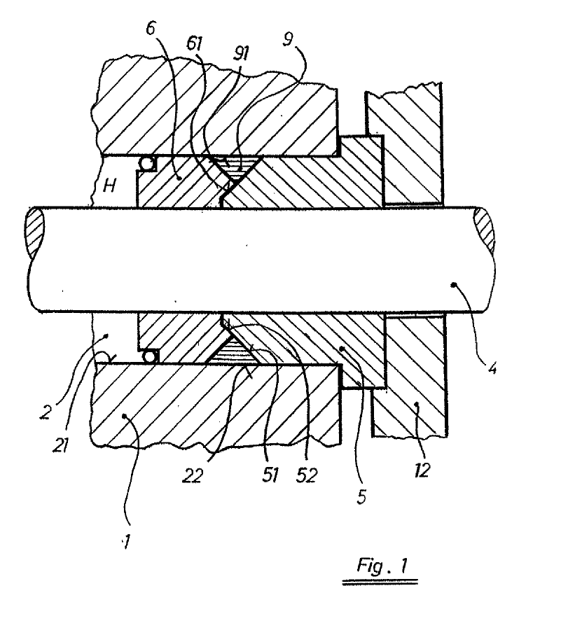

With a seal shown in FIG. 1 of a high-pressure container 1 and a moveable part, a sleeve 5 projecting into a bore 2 of a high-pressure container 1 is fixed in a stable and essentially motionless manner by means of a detachable holder element 12. The high-pressure container can be a device according to European Patent Application No. 0 505 352 B1, e.g., a high-pressure pump with moved handled, or can be some other high-pressure container device known in the art.

The sleeve 5 has a conical surface 51, 52 on the front side toward the high-pressure side H, whereby an exterior area 51 of the same on the one hand and an exterior surface of a sleeve 5 on the other hand interact with a support ring 9, in this case triangular in cross section. A cylindrical exterior surface 91 of a support ring 9 is thereby positioned in a pressing manner against the interior surface 22 of a bore 2, because a ring or pressing ring 6 is pressurized by the high pressure H.

Contact surfaces and sealing surfaces of high-pressure devices 1 between parts of metal, such as in particular a support ring 9, and the surface 22 of a bore 2 can cause signs of wear irrespective of a shape of the support ring 9. According to the invention, at least one part in the contact area or sealing area of the metallic parts has a PVD and/or CVD and/or PACVD coating.

The methods and an embodiment of a respective coating according to the invention and the conditions for this are prior art and part of the knowledge of one skilled in the art. This applies both to nitride compounds, carbide compounds, carbonitride compounds and optionally compounds with oxide and like layers and to a carbon layer containing metal and/or free of metal of, e.g., a “multiple-layer” coating.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### List of Reference Numbers

1 High-pressure container or high-pressure cylinder
12 Holder element
2 Opening or bore in the high-pressure container
21 Interior surface of the opening
22 Interior surface of the opening in the sealing area
4 Moveable part
5 Sleeve or metallic bushing
51 Front exterior area of the sleeve
52 Front interior area of the sleeve adjacent to the moveable part
6 Ring or pressing ring
61 Interior area of the pressure surface of the ring
9 Support ring or sealant
91 Exterior surface of the support ring
H High-pressure side

What is claimed:

1. Seal of parts moveable relative to one another of high-pressure devices, in particular of plungers moved in an oscillating manner of high-pressure pumps, for liquid media, comprising a metallic high-pressure container or a like cylinder (1), into the opening (2) of which the moveable part (4) and, coaxially around this part toward the high-pressure side (H), a sleeve (5), in particular a metallic bushing, project, and a metallic support ring (9) on the front exterior area (51) of the projecting sleeve (5) bears against the interior surface (22) of the opening (2) of the high-pressure container (1) and against a ring (6) or a pressing ring, which ring (6) is in contact with the sleeve (5) in the interior area (61) or in the front area (52) adjacent to the moved part (4), characterized in that at least the exterior surface (91) of the support ring (9) and/or at least the interior surface (22) of the opening (2) of the high-pressure container (1), which surface bears against the support ring or the sealant (9), has at least one coating applied according to a PVD (Physical Vapor Deposition) method, and/or a CVD (Chemical Vapor Deposition) method, and/or in particular a PACVD (Plasma-Assisted Chemical Vapor Deposition) method.

2. Seal according to claim 1, characterized in that the support ring (9) and/or the high-pressure container (1) with the opening (2) is (are) made of a stainless steel with a hardness of more than 28 HRC, preferably of a stainless steel with special additives, in particular of a steel according to DIN material no. 1.4545.

3. Seal according to claim 1, characterized in that the coating is formed of several individual layers, as a so-called “multiple layer” coating.

4. Seal according to claim 1, characterized in that the coating or at least one layer of the same is formed as a carbide, nitride or carbonitride layer.

5. Seal according to claim 1, characterized in that the coating or the interior layer of the multiple-layer coating, which layer is connected to the partial surface, is formed with chromium nitride.

6. Seal according to claim 1, characterized in that the coating or the exterior layer of the multiple-layer coating is formed as a carbon layer containing metal or free of metal.

7. Seal according to claim 1, characterized in that the exterior surface (91) of the support ring (9) and the interior surface (23) of the opening (2) bear a (CrN) coating.
